(19) United States
(12) Patent Application Publication
(10) Pub. No.: US 2010/0034291 A1
(43) Pub. Date: Feb. 11, 2010

(54) APPARATUS FOR PROCESSING DIGITAL IMAGE, METHOD OF CONTROLLING THE SAME, AND RECORDING MEDIUM HAVING RECORDED THEREON THE METHOD

(75) Inventor: Deok-eun Cho, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/534,223

(22) Filed: Aug. 3, 2009

(30) Foreign Application Priority Data
Aug. 6, 2008 (KR) 10-2008-0077046

(51) Int. Cl. H04N 7/12

(52) U.S. Cl. 375/240.25; 375/240.26; 375/E07.076; 375/E07.027

(57) ABSTRACT

An apparatus for processing a plurality of images includes a still image encoder configured to compress the plurality of images to generate still image files; a resize unit configured to resize the plurality of images to generate frame image data; a moving image encoder configured to compress the frame image data corresponding to at least two images to generate a moving image file; and a file generator configured to generate a consecutively captured image file including the still image file and the moving image file. The apparatus provides the advantage of being able to display the captured images as a movie relatively quickly while at the same time providing access to high quality still images of the displayed captured images. A method of controlling the apparatus, and a recording medium having encoded thereon computer executable instructions for controlling the apparatus are disclosed.

### CROSS-REFERENCE TO RELATED PATENT APPLICATION

This application claims the benefit of Korean Patent Application No. 10-2008-0077046, filed on Aug. 6, 2008 in the Korean Intellectual Property Office, the entire contents of which is incorporated herein in by reference.

### BACKGROUND OF THE INVENTION

1. Field of the Invention

The present invention relates to an apparatus for capturing and processing a sequence of digital images, and a method of controlling the apparatus, and a recording medium having recorded thereon the method.

2. Description of the Related Art

Due to the development of complementary metal-oxide semiconductor (CMOS) (imaging devices), the availability of digital cameras capable of high-speed consecutive photographing has increased. Recently, high-speed digital cameras, which can capture thirty consecutive images per second, have been developed.

In a conventional method of storing consecutively captured images, each still image is compressed so as to form and store three JPEG files. In general, a JPEG file includes original image data and its thumbnail data. In order to reproduce the still image, a JPEG file is decoded to reproduce thumbnail data. Then, if a user desires, the original data is reproduced.

Because performance imaging devices have improved, high-quality and high-speed photographing is possible. Accordingly, the capacity of each JPEG file increases and the number of files also increases, so that more storage space is required. For example, a nine (9) million-pixel CMOS may input an image having a size of ten (10) Mbytes and capture ten (10) consecutive images per second for six seconds, thereby generating sixty (60) images. These images are resized so that the original image data of five (5) Mbytes and thumbnail data of 0.5 Mbytes may be formed. Thus, JPEG files for each image have a size of 5.5 Mbytes. As sixty JPEG files are generated, consecutively captured image files have a capacity of approximately three-hundred-and-thirty (330) Mbytes. Therefore, more storage space for the images is required than before.

In addition, it may be time consuming to display the JPEG files. For example, to display a high-quality image, each JPEG file must be retrieved and then decoded to restore the original image data for display. It may be inconvenient for the user to have to wait for JPEG files to be retrieved and decoded.

### SUMMARY OF THE INVENTION

The present disclosure provides an apparatus for processing a digital image capable of reducing storage spaces for consecutively captured images and for reproducing the images rapidly and conveniently, a method of controlling the apparatus, and a recording medium having recorded thereon the method.

An apparatus for processing a plurality of images is disclosed. The apparatus includes a still image encoder configured to compress the plurality of images to generate still image files; a resize unit configured to resize the plurality of images to generate frame image data; a moving image encoder configured to compress the frame image data corresponding to at least two images to generate a moving image file; and a file generator configured to generate a consecutively captured image file including the still image file and the moving image file.

The plurality of images may be consecutively input in response to a selection from a user.

The resize unit may be configured to resize the plurality of image to generate frame image data having an image size of at least one of: high definition (HD) and full high definition (FHD) resolution.

The file generator may be further configured to generate moving image thumbnail data representative of the generated frame image data corresponding to at least two images.

The moving image thumbnail data may be formed by adjusting any one frame image data selected from the frame image data.

The apparatus may further include a search unit configured to search for the moving image file and the still image file in the consecutively captured image file; a still image decoder configured to decode the still image file; and a moving image decoder configured to decode the moving image file.

The apparatus may further include a search unit configured to search for the moving image file, the still image file, and the moving image thumbnail data in the consecutively captured image file.

The apparatus may further include a display unit configured to display images, frame image data, and moving image thumbnail data.

The search unit may be configured to: in response to a selection of a moving image thumbnail data, to search for a moving image file in a consecutively captured image file which corresponds to the moving image thumbnail data selected.

The apparatus, may be configured to: decode the moving image file; display the at least two captured images from the moving image file as a movie; and in response to the selection of a displayed captured image, retrieve and decode the still image file corresponding to the selected displayed captured image, and display the captured image from the still image file.

The apparatus may be further configured to: in response to a user selection, store or delete the still image file corresponding to the displayed captured image.

The apparatus may be further configured to: retrieve the moving image thumbnail data from among the consecutively captured image file; and display the moving image thumbnail data; and in response to a user selection of the moving image thumbnail data, retrieve and display as a movie the moving picture file from the consecutively captured image file corresponding to the selected moving image thumbnail data.

The still image encoder may be further configured to compress using JPEG the plurality of images to generate still image files; and the moving image encoder is further configured to compress using MPEG the frame image data corresponding to at least two images to generate a moving image file.

A method of controlling an apparatus for a consecutive photographing mode is disclosed. The method includes consecutively capturing images; generating still image files by compressing the captured images; resizing the captured images to generate frame image data from the captured images; generating a moving image file by compressing the frame image data corresponding to at least two captured images; and generating a consecutively captured image file including the still image files and the moving image file.

The method may further include: decoding the moving image file; displaying the at least two captured images from the moving image file as a movie; and in response to the selection of a displayed captured image, retrieving and decoding the still image file corresponding to the selected displayed captured image, and displaying the captured image from the still image file.

The method may further include in response to a user selection, storing or deleting the still image file corresponding to the displayed captured image from the still image file.

The plurality of images may be consecutively captured over a period of time in response to a user selection.

The frame image data may have an image size of an high definition (HD) or full high definition (FHD) resolution.

Generating a moving image file may further include generating a moving image file by encoding the frame image data corresponding to at least two captured images, and by generating a moving image thumbnail representative of the at least two captured images.

The method may further include retrieving the moving image thumbnail data from among the consecutively captured image file; and displaying the moving image thumbnail data; and in response to a user selection of the moving image thumbnail data, retrieving and displaying as a movie the moving picture file from the consecutively captured image file corresponding to the selected moving image thumbnail data.

The method may further include searching and retrieving the still image file in the consecutively captured image file; decoding the still image file; and displaying the captured image from the decoded still image file.

Generating still image files may further include generating still image files by encoding using JPEG the captured images; and wherein generating a moving image file further comprises: generating a moving image file by encoding using MPEG the frame image data corresponding to at least two captured images.

A computer-readable medium encoded with a computer-executable instructions to perform a method is disclosed. The method includes consecutively capturing images; generating still image files by compressing the captured images; resizing the captured images to generate frame image data from the captured images; generating a moving image file by compressing the frame image data corresponding to at least two captured images; and generating a consecutively captured image file including the still image files and the moving image file.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a block diagram of an example of an apparatus for processing a digital image according to an embodiment of the present invention;

FIG. 2 is a block diagram of an example of a digital signal processor (DSP) included in the apparatus for processing a digital image of FIG. 1;

FIG. 3 illustrates an example of a structure of a consecutively captured image file generated from an apparatus for processing a digital image according to an embodiment of the present invention;

FIG. 4 is a flowchart illustrating an example of a method of controlling an apparatus for processing a digital image according to an embodiment of the present invention;

FIG. 5 is a flowchart illustrating an example of a method of controlling an apparatus for processing a digital image according to another embodiment of the present invention; and

FIGS. 6 through 8 illustrate examples of screens on which consecutively captured image files explained in FIG. 5 are reproduced.

### DETAILED DESCRIPTION OF THE INVENTION

Therefore there is a need in the art for an apparatus for processing a plurality of images. The apparatus including a still image encoder configured to compress the plurality of images to generate still image files; a resize unit configured to resize the plurality of images to generate frame image data; a moving image encoder configured to compress the frame image data corresponding to at least two images to generate a moving image file; and a file generator configured to generate a consecutively captured image file including the still image file and the moving image file. The apparatus provides the advantage of being able to display the captured images as a movie without excessive delay while at the same time providing access to high quality still images of the displayed captured images.

Hereinafter, the present disclosure will be described more fully with reference to the accompanying drawings, in which exemplary embodiments of the disclosure are shown.

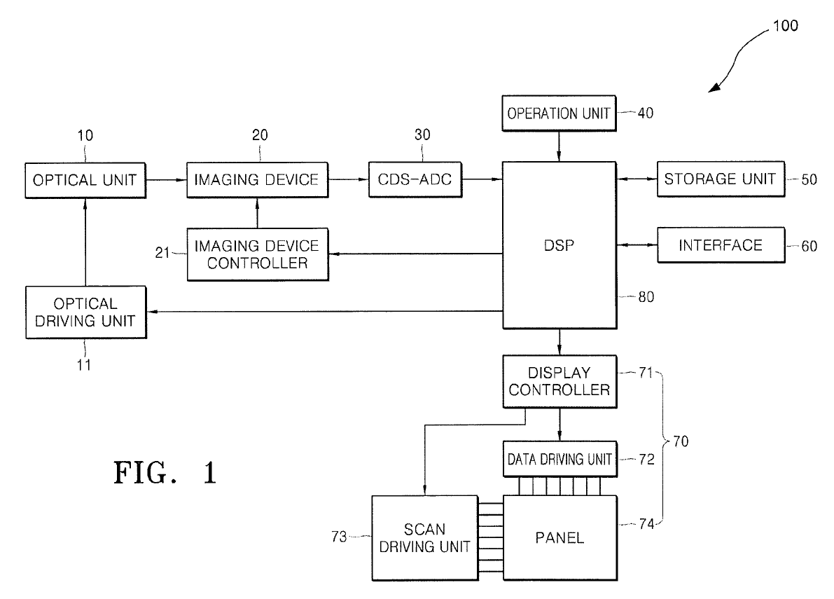

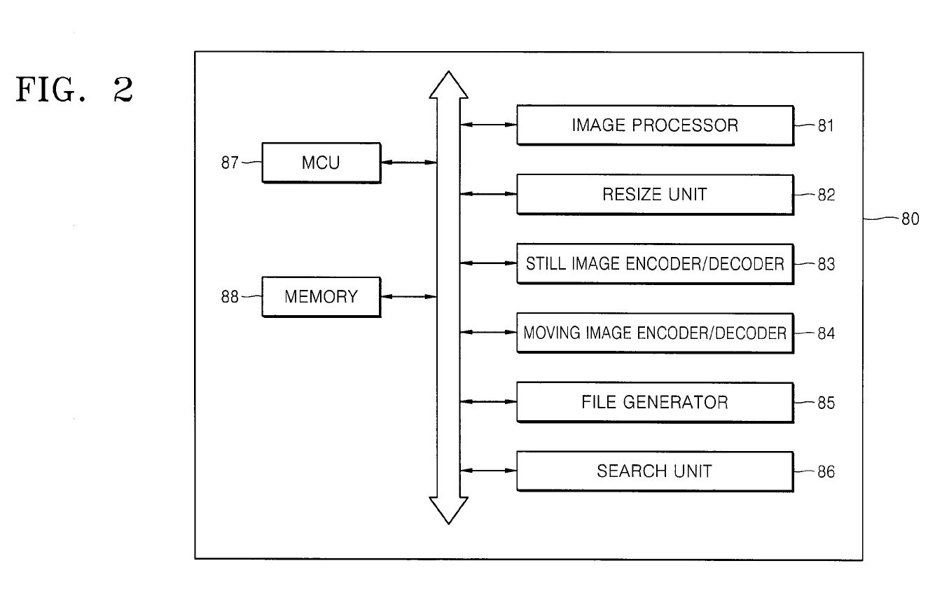

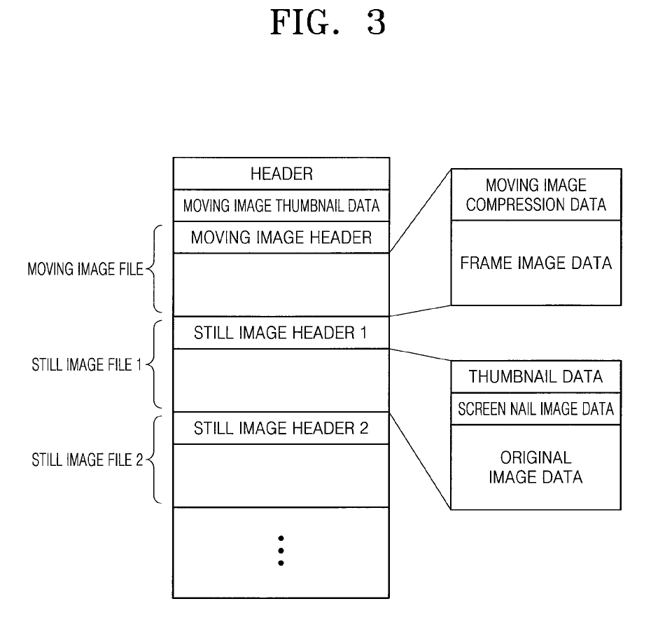

FIG. 1 is a block diagram of an example of an apparatus for processing a digital image according to an embodiment of the present invention, FIG. 2 is a block diagram of an example of a digital signal processor (DSP) included in the apparatus for processing a digital image of FIG. 1, and FIG. 3 illustrates a structure of a consecutively captured image file generated by an apparatus for processing a digital image according to an embodiment of the present disclosure.

In the current embodiment, a digital camera is illustrated as the apparatus for processing a digital image.

Referring to FIG. 1, a digital camera 100 includes an optical unit 10, an optical driving unit 11, an imaging device 20, an imaging device controller 21, a CDS-ADC 30, an operation unit 40, a storage unit 50, an interface 60, a display unit 70, and a DSP 80.

The optical unit 10 receives an optical signal from an object and provides the input signal to the imaging device 20. The optical unit 10 may include at least one of a zoom lens and a focus lens, wherein the zoom lens narrows or widens a viewing angle and the focus lens focuses an object. In addition, the optical unit 10 may further include an aperture for controlling light quantity.

The optical driving unit 11 controls a location of the lens and opening of the aperture. The location of the lens is moved to focus the object. In addition, opening of the aperture is controlled, thereby controlling light quantity. According to a control signal automatically generated by an image signal input in real-time or a control signal manually input by a user, the optical driving unit 11 may control the optical unit 10.

The optical signal penetrating the optical unit 10 reaches a light receiving surface of the imaging device 20 and forms an image of an object. The imaging device 20 may use a charge coupled device (CCD) or a complementary metal oxide semiconductor image sensor (CIS) which converts an optical signal into an electric signal. The sensitivity of the imaging device 20 may be controlled by the imaging device controller 21. The imaging device controller 21 may control the imaging device 20 according to a control signal automatically generated by an image signal that is input in real-time or a control signal manually input by operation of a user.

The imaging device 20 according to the current embodiment may have nine million pixels and input ten or more images per second. Thus, the digital camera 100 including the imaging device 20 can consecutively photograph images at high speed.

The CDS-ADC 30 processes the image signal output from the imaging device 20 so as to remove high frequency noise and controls the amplitude (auto gain control (AGC)), thereby converting the signal into a digital signal. As the image signal output from the imaging device 20 is an analog signal, the CDS-ADC 30 digitizes the analog signal and generates an image data. Then, the CDS-ADC 30 outputs the image data to the DSP 80.

The image data in regard to the present disclosure denotes a group of data forming one image. This will apply to image data illustrated in embodiments and claims below.

The operation unit 40 is where a control signal from outside, such as from a user, can be input. The operation unit 40 includes a release button, a power button, a wide angle-zoom button and a telescopic-zoom button, and various functional buttons, wherein the release button exposes the imaging device 20 to light for a predetermined time and generates a shutter-release signal for photographing, the power button generates a control signal for providing a power source, the wide angle-zoom button and the telescopic-zoom button respectively widens and narrows an viewing angle according to the input, and various functional buttons for selecting a mode such as text input, photographing, and reproduction mode and functions such as white balance and exposure. The operation unit 40 may be realized in any way, such as a keyboard, a touch pad, a touch screen, or a remote controller, so long a user can perform an input operation.

The shutter-release button in the operation unit 40 controls the start of consecutive photographing. That is, when a user selects a consecutive photographing mode through the functional button, determines an object, and presses the shutter-release button, a shutter-release signal is generated and consecutive photographing is performed.

In addition, the digital camera 100 includes the storage unit 50 which stores programs such as an operation system and application system for driving the digital camera. In addition, the storage unit 50 may temporarily store data needed to carry out an operation or process result data. Also, the storage unit 50 may be internally or externally connected to the digital camera 100 and thus may store consecutively captured image files and various information that is needed to the program. The storage unit 50 may be formed of a plurality of memory devices according to storage preservation abilities and stored data.

Moreover, the digital camera 100 includes the interface 60. The interface 60 exchanges information required by external digital devices and the digital camera 100. That is, the interface 60 communicates information with external digital devices and may be USB, RS-232, or IEEE 1394.

The digital camera 100 includes the display unit 70 which displays an operational state of the digital camera 100 or information regarding images captured by the digital camera 100. The display unit 70 may include a display controller 71, a data driving unit 72, a scan driving unit 73, and a panel 74. The display controller 71 converts the image data provided from the DSP 80 according to a displaying process of the panel 75 and outputs the converted data to the data driving unit 72 and the scan driving unit 73. The data driving unit 72 and the scan driving unit 73 respectively provide a data signal and a scanning signal to the panel 74. The panel 74 displays an image according to the data signal and the scanning signal. Examples of the panel 74 may include a liquid crystal display (LCD) panel, an organic light emitting display (OLED) panel, and an electrophoretic display (EDD).

The digital camera 100 includes the DSP 80 which digital signal processes the input image data and controls each element in the digital camera 100 according to the digital signal and an externally input signal.

The DSP 80 will now be described in more detail with reference to FIG. 2.

Referring to FIG. 2, the example of a DSP 80 includes an image processor 81, a resize unit 82, a still image encoder/decoder 83, a moving image encoder/decoder 84, a file generator 85, a search unit 86, a micro controller unit (MCU) 87, and a memory 88.

In order to convert an image signal suitable for human vision, the image processor 81 performs image signal processing such as gamma correction, color filter array interpolation, color correction, and color enhancement. Also, the image processor 81 may perform an auto white balance algorithm or an auto exposure algorithm, when functions thereof are set in the image processor 81.

The resize unit 82 decreases capacity of image data on which image signal processing is performed and controls a size of the image. The resize unit 82 according to the current embodiment controls the capacity of the image data of the original data input from the image processor 81 and generates frame image data. The frame image data can be used to display high definition (HD) quality or full high definition (FHD) quality images. In addition, the resize unit 82 may decrease the capacities of the frame image data and/or the original image data and generate thumbnail image data. Also, the resize unit 82 may generate screen nail image data.

For example, if the imaging device 20 can input a nine (9) million-pixel image, the resize unit 82 decreases the capacity of the original image data provided from the imaging device 20 and generates frame image data. The frame image data may have an image size of 1920×1080 (FHD-level quality) or 1080×720 (HD-level quality). In addition, the resize unit 82 may generate still image thumbnail data having an image size of 160×120 or screen nail image data having an image size of 640×480.

The resize unit 82 re-samples the image data provided from the image processor 81 so as to input the re-sampled image to a predetermined filter and as a result of filtering, may form image data having a desired size (frame image data, still image thumbnail data, moving image thumbnail data, and screen nail image data) based on a weighted average of a plurality of pixels. However, the above is just an exemplary description of the operation of the resize unit 82 and the present disclosure is not limited thereto. Other methods of resizing may be used including methods of forming at least two pieces of frame image data which form moving image data by controlling the capacity of the original image data through the resize unit 82.

The still image encoder/decoder 83 compresses the image data provided from the image processor 81 and generates a still image file. Alternatively, the still image file is decoded to restore the image data. The still image file may further include the still image thumbnail data provided from the resize unit 82 or the screen nail image data. In the encoding/decoding for generating the still image file, JPEG compression may be used.

The moving image encoder/decoder 84 compresses the frame image data and generates a moving image file. A plurality of images are input to the optical unit 10 and the imaging device 20 by the same photographing signal for a predetermined time, image data for each of the at least two images from among the plurality of images is generated, and the frame image data corresponding to the image data is generated. Here, the frame image data corresponding to each of the at least two pieces of image data from among the plurality of images is generated. Thus, a plurality of frame image data is generated. A moving image file which reproduces the plurality of frame image data a predetermined number of times for one second may be generated. In addition, the moving image file is decoded and the frame image data may be restored. In the encoding/decoding for generating the moving image file, the MPEG standard may be used.

The file generator 85 generates consecutively captured image files including the still image file and the moving image file. The consecutively captured image files include a plurality of still image files for the plurality of images input by the same signal for a predetermined time and moving image files having the frame image data corresponding to the at least two images from among the plurality of images. The consecutively captured image files may further include moving image thumbnail data of the moving image file. The moving image thumbnail data is representative of the frame image data. The moving image thumbnail data may be any one of the frame image data forming the moving image file or a data formed by resizing any one of the frame image data.

The file generator 85 adds a header and a file name respectively corresponding to the still image file and the moving image file to the header and generates the consecutively captured image file. That is, the file generator 85 can generate the consecutively captured image file including the header, the moving image thumbnail data, the plurality of still image files, and the moving image file including additional information. The structure of the consecutively captured image file is illustrated in FIG. 3. The moving image file also includes a moving image header, moving image compression data, and the frame image data including the header and moving image file name, which correspond to the moving image data. In addition, the still image file includes the still image header, the (still image) thumbnail data, the screen nail image data, and the original image data.

Referring back to FIG. 2, the DSP 80 may further include the search unit 86. The search unit 86 searches for the moving image thumbnail data, the moving image file, and the still image file in the consecutively captured image files. In order to reproduce a plurality of consecutively captured image files, the search unit 86 firstly searches for the moving image thumbnail data included in each of the plurality of consecutively captured image files. Then, when the moving image thumbnail data is displayed and any one of the moving image thumbnail data is selected by a user, the consecutively captured image file corresponding to the selected moving image thumbnail data is selected. Then, the search unit 86 searches for the moving image file of the selected consecutively captured image file. When the moving image file is displayed and the user selects any one of the plurality of frame image data forming the moving image file, the search unit 86 searches for the still image file which corresponds to the selected frame image data. The searched for still image file may be decoded to display the original image data or the searched for still image file may be selected, stored, or deleted.

The MCU 87 allows the constituent members of the DSP 80 to perform the corresponding operations according to the control signals input by the user through the operation unit (as in the operation unit 40 of FIG. 1) or program stored in the storage unit (as in the storage unit 50 of FIG. 1). In addition, the memory 88 temporarily stores data or result data needed while the operations are carried out by the constituent members of the DSP 80.

As such, in the present disclosure, has the advantage that when a plurality of images are input by the same signal as in consecutive photographing, the images can be conveniently and rapidly displayed in a reproduction mode with respect to, in particular, a plurality of images input as a result of high-speed consecutive photographing. The frame image data, which corresponds to the input images, is generated and the moving image file using the frame image data is generated and reproduced so that the plurality of images can be rapidly and conveniently checked. The frame image data is formed as a HD and FHD image so that the plurality of images can be rapidly checked with high-definition in the digital camera 100 or by using a TV connected to the digital camera 100.

For example, a nine (9) million-pixel imaging device 20 can input an image having a size of 10 Mbytes and generate sixty images by capturing ten consecutive images per second for six seconds. The images are resized and the original image data and HD-level frame image data are formed. The moving image file generated using a plurality of frame image data has a capacity of approximately 4 Mbytes. Accordingly, the original image data has a capacity of 5 Mbytes and the generated moving image file has a capacity of 4 Mbytes so that the consecutive captured image file including the original data and the moving image file has a capacity of approximately 304 Mbytes. Thus, compared with the above-described example, the storage space of approximately 30 Mbytes can be saved. Also, sixty JPEG files are formed. According to the current embodiment, one consecutively captured image file is formed and thus management thereof is easy.

Hereinafter, the operation of the digital camera 100 is described.

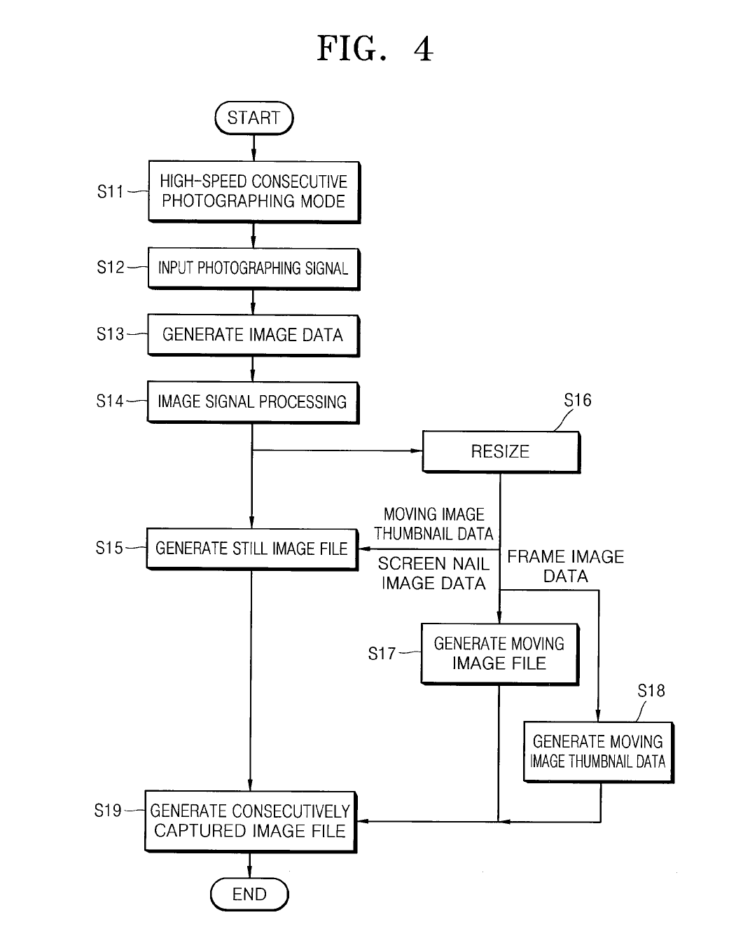

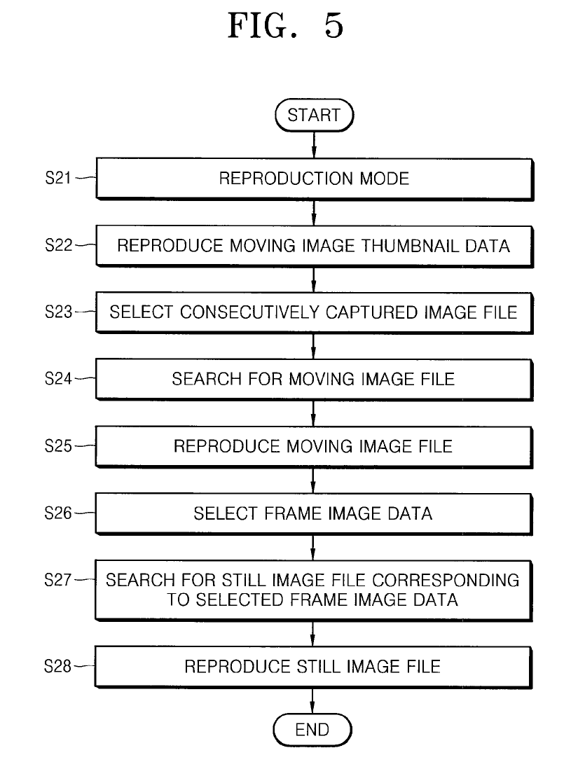

Firstly, an example of a method of generating the consecutively captured image file by executing a photographing mode is described with reference to FIG. 4 and then an example of an operational method of a reproduction mode for the consecutively captured image file is described with reference to FIG. 5.

Referring to FIG. 4, a high-speed consecutive photographing mode of the digital camera is executed in operation 11. In the high-speed consecutive photographing mode, images are captured at high speed for a predetermined time as in capturing thirty still images per second.

In operation 12, a photographing signal is input in the consecutive photographing mode. In the high-speed consecutive photographing mode, photographing is executed by the same signal, more specifically, a shutter-release signal. That is, in general photographing, the shutter-release signal is input thirty times so as to form thirty still images. However, in the high-speed consecutive photographing mode, the shutter-release signal is input once and thirty still images can be formed.

In operation 13, a plurality of still images are input for a predetermined time by the photographing signal and image data respectively corresponding to the still images is generated. Here, the generated image data may be denoted as the original image data.

In operation 14, image signal processing such as brightness and color correction, and white balance is performed on the image data. The original image data may be image data on which the image signal processing is performed. That is, the original image data in the present invention may be denoted as image data before resizing.

In operation 15, the image data on which predetermined image signal processing is performed is encoded to generate a still image file.

The image data is resized in operation 16. After the resizing, the frame image data, the still image thumb nail data, and the screen nail image data may be generated.

For example, when the original image data is input through a nine (9) million-pixel imaging device, the capacity of the original image data is increased to have an image size of 1920×1080 (FHD-level quality) or to generate the frame image data having an image size of 1080×720 (HD-level quality). In addition, the still image thumbnail data having an image size of 160×120 and the screen nail image data having an image size of 640×480 can be generated.

In operation 17, the frame image data having a reduced capacity due to resizing is compressed and the moving image file is generated.

More specifically, the image data respectively corresponding to the plurality of input images is generated in operation 13 and the image data forming each image is compressed to generate the still image file in operation 15. Thus, a plurality of still image files which correspond to the plurality of images are generated. Also, the image data respectively forming the plurality of images is resized to generate the frame image data. Accordingly, a plurality of frame image data corresponding to the plurality of images is generated and in operation 17, the moving image file is generated using the plurality of frame image data.

The still image thumbnail data and the screen nail image data generated by resizing the images may be used to generate the still image file in operation 15.

The frame image data generated by resizing may be formed as the moving image file in operation 17, and in operation 18, the moving image thumbnail data is generated using the frame image data. Any one of the frame image data which corresponds to the plurality of images may be used as the moving image thumbnail data. Also, any one of the frame image data may be resized to be used as the moving image thumbnail data.

In operation 19, the consecutively captured image files including the still image file, the moving image file, and the moving image thumbnail data are generated.

Here, a plurality of consecutively captured image files may be generated and stored.

When the plurality of consecutively captured image files are stored, a method of generating any one of the consecutively captured image files is performed, which will now be described.

Referring to FIG. 5, a reproduction mode is firstly executed in operation 21.

In operation 22, the moving image thumbnail data respectively included in the plurality of consecutively captured image files is reproduced. Thus, the plurality of moving image thumbnail data is displayed.

In operation 23, a user selects any one of the moving image thumbnail data. That is, the consecutively captured image file corresponding to the selected moving image thumbnail data is selected.

In operation 24, the moving image file included in the selected consecutively captured image file is searched for.

In operation 25, the searched for moving image file is decoded and reproduced. Here, the plurality of frame image data forming the moving image file is restored and the plurality of frame image data is displayed. The frame image data is for displaying an HD or FHD-level quality image and thus can be easily displayed in a HD or FHD-level display device. Thus, the present disclosure has the advantage that the image data for displaying the HD or FHD-level quality image is not separately generated from the still image file or the original image data and the moving image file is reproduced so that HD or FHD-level images may be easily and rapidly displayed.

In operation 26, any one of the frame image data from among the plurality of frame image data is selected.

In operation 27, the still image file, which corresponds to the selected frame image data, is searched for.

In operation 28, the searched for still image file is decoded and reproduced. The still image file is restored and the image data included in the still image file is displayed. According to specification of the display unit, the original data may be displayed or the still image thumbnail data or the screen nail image data may be displayed.

In the current embodiment, the still image file is searched for and the searched for still image file is selectively stored or deleted.

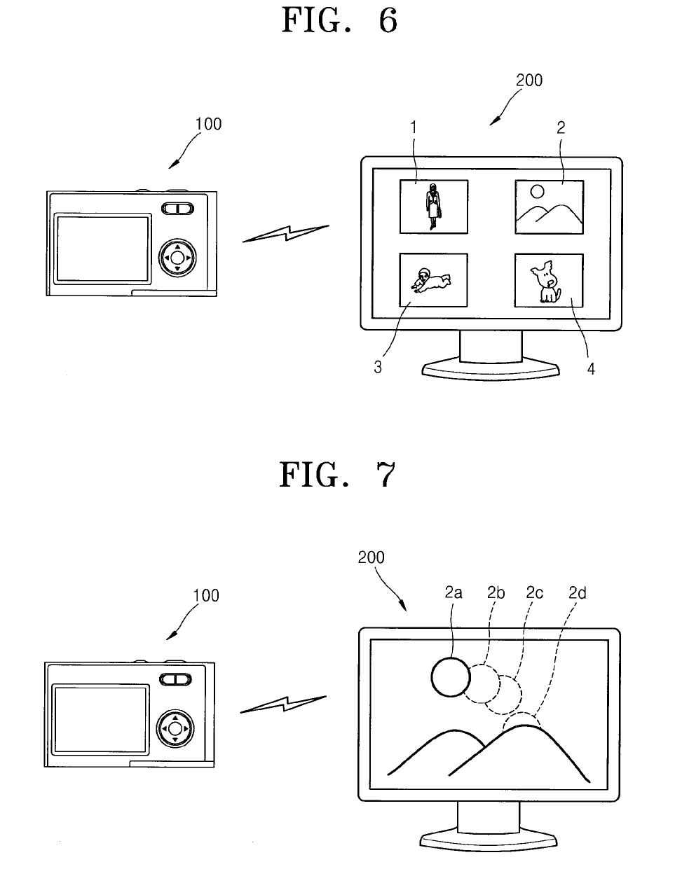

FIGS. 6 through 8 illustrate screens on which consecutively captured image files as explained in FIG. 5 are reproduced. In the current embodiment, the consecutively captured image files generated in the digital camera 100 are reproduced in an HD TV or an FHD TV. More specifically, in the digital camera 100, the image data of the consecutively captured image files are restored and the restored image data is transmitted to the HD TV or the FHD TV so as to be reproduced thereon.

Referring to FIG. 6, the digital camera 100 includes the plurality of consecutively captured image files. The digital camera 100 and a TV 200 are wirelessly connected to each other. A reproduction mode is executed in the digital camera 100 and the moving image thumbnail data of the plurality of consecutively captured image files is restored by default, thereby displaying the moving image thumbnail data. The moving image thumbnail data is transmitted from the digital camera 100 to the TV 200 and the moving image thumbnail data is reproduced in the TV 200. More specifically, the moving image thumbnail data of first through fourth consecutively captured image files (1 through 4) is displayed on one screen.

When the second consecutive photographed file (file 2) is selected from among the moving image thumbnail data of the first through fourth consecutively captured image files (files 1 through 4), the moving image file of the second consecutive photographed file (file 2) is reproduced as illustrated in FIG. 7. The moving image file of the second consecutive photographed file may be displayed as a movie as illustrated in FIG. 7. The plurality of frame image data forming the moving image file is restored in the digital camera 100 and the plurality of restored frame images are displayed on the TV 200. If the consecutively captured image files are formed by inputting four still images per second, the moving image file including the frame image data which respectively corresponding to the still images can be formed. When the moving image file is reproduced, four frame images can be displayed. A first frame image 2a is an image showing the sun above a mountain. A second frame image 2b, a third frame image 2c, and a fourth frame image 2d are images respectively showing the sun gradually setting behind the mountain. As such, the sunset images can be displayed in a moving image. Here, the images have an HD or FHD-level quality. Thus, high-definition images can be displayed on the HD or FHD TV 200 for previewing.

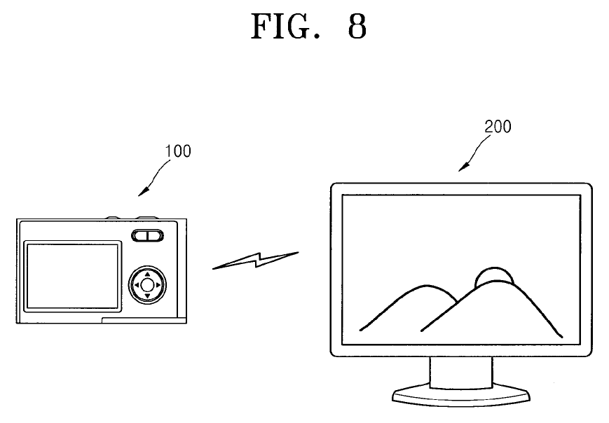

FIG. 8 illustrates the original image, which corresponds to the fourth frame image 2d from among the first through fourth frame images 2a through 2d, being displayed.

According to the present invention, the consecutively captured images can be managed as one consecutively captured image file so that the storage space required for storing the images can be reduced.

In addition, since the consecutively captured image file includes the still image files of each of the images and the moving image file including the frame image data of the images, the moving image file can be reproduced without decoding and resizing the still image file including the original image so as to display the decoded and resized file, for previewing, so that the consecutively captured images can be checked easily and rapidly. In particular, the frame image data forming the moving image files allows for an HD or FHD-level quality image and thus high-definition images can be rapidly and easily displayed on an HD or FHD TV

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

The various illustrative units, logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for processing a plurality of images, comprising:
a still image encoder configured to compress the plurality of images to generate still image files;
a resize unit configured to resize the plurality of images to generate frame image data;
a moving image encoder configured to compress the frame image data corresponding to at least two images of the plurality of images to generate a moving image file; and
a file generator configured to generate a consecutively captured image file including the still image file and the moving image file.

2. The apparatus of claim 1, wherein the plurality of images are consecutively input in response to a selection from a user.

3. The apparatus of claim 1, wherein the resize unit is configured to resize the plurality of image to generate frame image data having an image size of at least one of: high definition (HD) and full high definition (FHD) resolution.

4. The apparatus of claim 1, wherein the file generator is further configured to generate moving image thumbnail data representative of the generated frame image data corresponding to at least two images.

5. The apparatus of claim 4, wherein the moving image thumbnail data is formed by adjusting any one frame image data selected from the frame image data.

6. The apparatus of claim 1, further comprising:
a search unit configured to search for the moving image file and the still image file in the consecutively captured image file;
a still image decoder configured to decode the still image file; and
a moving image decoder configured to decode the moving image file.

7. The apparatus of claim 4, further comprising:
a search unit configured to search for the moving image file, the still image file, and the moving image thumbnail data in the consecutively captured image file.

8. The apparatus of claim 1, further comprising:
a display unit configured to display images, frame image data, and moving image thumbnail data.

9. The apparatus of claim 8, wherein the search unit is further configured to:
in response to a selection of a moving image thumbnail data, to search for a moving image file in a consecutively captured image file which corresponds to the moving image thumbnail data selected.

10. The apparatus of claim 8, wherein the apparatus is configured to:
decode the moving image file;
display the at least two captured images from the moving image file as a movie; and
in response to the selection of a displayed captured image,
retrieve and decode the still image file corresponding to the selected displayed captured image, and
display the captured image from the still image file.

11. The apparatus of claim 10, wherein the apparatus is further configured to:
in response to a user selection,
store or delete the still image file corresponding to the displayed captured image.

12. The apparatus of claim 8, wherein the apparatus is further configured to:
retrieve the moving image thumbnail data from among the consecutively captured image file; and
display the moving image thumbnail data; and
in response to a user selection of the moving image thumbnail data,
retrieve and display as a movie the moving picture file from the consecutively captured image file corresponding to the selected moving image thumbnail data.

13. The apparatus of claim 1, wherein:
the still image encoder is further configured to compress using JPEG the plurality of images to generate still image files; and
the moving image encoder is further configured to compress using MPEG the frame image data corresponding to at least two images to generate a moving image file.

14. A method of controlling an apparatus for a consecutive photographing mode, the method comprising:
consecutively capturing images;
generating still image files by compressing the captured images;
resizing the captured images to generate frame image data from the captured images;
generating a moving image file by compressing the frame image data corresponding to at least two consecutively captured images; and
generating a consecutively captured image file including the still image files and the moving image file.

15. The method of claim 14, further comprising
decoding the moving image file;
displaying the at least two captured images from the moving image file as a movie; and
in response to the selection of a displayed captured image,
retrieving and decoding the still image file corresponding to the selected displayed captured image, and
displaying the captured image from the still image file.

16. The method of claim 15, further comprising:
in response to a user selection,
storing or deleting the still image file corresponding to the displayed captured image from the still image file.

17. The method of claim 14, wherein the plurality of images are consecutively captured over a period of time in response to a user selection.

18. The method of claim 14, wherein the frame image data has an image size of an high definition (HD) or full high definition (FHD) resolution.

19. The method of claim 14, wherein generating a moving image file further comprises:
generating a moving image file by encoding the frame image data corresponding to at least two captured images, and by generating a moving image thumbnail representative of the at least two captured images.

20. The method of claim 19, further comprising:
retrieving the moving image thumbnail data from among the consecutively captured image file; and
displaying the moving image thumbnail data; and
in response to a user selection of the moving image thumbnail data,
retrieving and displaying as a movie the moving picture file from the consecutively captured image file corresponding to the selected moving image thumbnail data.

21. The method of claim 14, further comprising:
searching and retrieving the still image file in the consecutively captured image file;
decoding the still image file; and
displaying the captured image from the decoded still image file.

22. The method of claim 14, wherein generating still image files further comprises:
generating still image files by encoding using JPEG the captured images; and wherein generating a moving image file further comprises:
generating a moving image file by encoding using MPEG the frame image data corresponding to at least two captured images.

23. A computer-readable medium encoded with a computer-executable instructions to perform a method comprising:
consecutively capturing images;
generating still image files by compressing the captured images;
resizing the captured images to generate frame image data from the captured images;
generating a moving image file by compressing the frame image data corresponding to at least two captured images; and
generating a consecutively captured image file including the still image files and the moving image file.
